(19) United States
(12) Patent Application Publication
(10) Pub. No.: US 2007/0053121 A1
(43) Pub. Date: Mar. 8, 2007

(54) ELECTROSTATIC DISCHARGE (ESD) PROTECTION APPARATUS FOR PROGRAMMABLE DEVICE

(76) Inventors: Chyh-Yih Chang, Taipei County (TW); Yan-Nan Li, Taipei County (TW); Kun-Tai Wu, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,509

(22) Filed: Mar. 31, 2006

(30) Foreign Application Priority Data
Sep. 2, 2005 (TW) 94130055

(51) Int. Cl. H02H 9/00

(52) U.S. Cl. 361/56

(57) ABSTRACT

An electronic static discharge (ESD) protection apparatus for a programmable device is provided. The apparatus can improve the turn-on efficiency and reduce the surface area of the chip efficiently by providing a low impedance current path which can sufficiently lower the voltage of the programmable device when ESD occurs. The ESD protection apparatus includes an ESD protection device, a programmable device, a first circuit, a second circuit, and a third circuit.

### CROSS-REFERENCE TO RELATED APPLICATION

This application claims the priority benefit of Taiwan application serial no. 94130055, filed on Sep. 2, 2005. All disclosure of the Taiwan application is incorporated herein by reference.

### BACKGROUND OF THE INVENTION

1. Field of Invention

The present invention relates to an electrostatic discharge protection apparatus. More particularly, the present invention relates to an electrostatic discharge protection apparatus for a programmable device.

2. Description of Related Art

IC fuse trim cells are usually used in integrated circuits where data is to be written in permanently, such as the reference voltage data of analog to digital converter, digital to analog converter, voltage control oscillator, or reference data recorded in some digital circuits, and one-time program memory.

U.S. Pat. No. 6,654,304 provides a typical programmable fuse device (poly fuse trim cell) circuit as shown in FIG. 1: the poly fuse trim cell F1 determines whether to blow based on whether the N-type transistor MN0 is on. The voltage at endpoint 10 changes based on whether F1 is blown, and the voltage at the output terminal OUT is affected, but the circuit in the figure F1 is not protected by any electrostatic discharge (ESD) protection circuit, thus any damage due to static cannot be avoided.

U.S. Pat. No. 6,157,241 provides another typical programmable device (fuse) circuit as shown in FIG. 2. One end of the fuse 22 in the figure is coupled to the pad 24, and the other end thereof is coupled directly to the ground voltage line 26. The fuse 22 can be damaged easily if ESD occurs at the grounded end since it's not protected by any ESD protection circuit.

U.S. Pat. No. 6,762,918 provides another programmable device (fuse) circuit system as shown in FIG. 3. Neither end of the fuse 301 has ESD protection. When ESD induces the N-type field effect transistor (NFET) 308 to have the second breakdown, a low voltage level will be produced at the end of the NFET 308 coupled to the N-type field effect transistor 304, which results in wrong output level at the output terminal 310. Accordingly the correct status of the fuse 301 cannot be determined.

U.S. Pat. No. 6,762,918 provides another programmable device (fuse) circuit system as shown in FIG. 4. One end of the fuse 401 is coupled to the ground, the other end is coupled to the internal network and two ESD protection devices 414 and 416. The ESD protection capability of the fuse 401 is improved considerably, but it needs a larger chip area and cannot avoid damage to the fuse 401 caused by ESD at the ground VSS.

U.S. Pat. No. 6,469,884 provides another programmable device (fuse) circuit system as shown in FIG. 5. Please refer to the original document for the detailed specification, wherein neither end of the fuse 501 in FIG. 5 is protected by an ESD protection device.

U.S. Pat. No. 6,327,125 provides a method for applying a programmable device (fuse) in an integrated circuit, as shown in FIG. 6. Each of the ESD protection devices 710, 720, 730, and 740 has one end coupled to the fuse 701 and 703 respectively, and the other end coupled to the chip's I/O (input/output) pin 74 and 75 respectively, and the other ends of the fuse 701 and 703 are coupled to the voltage potential line 71 and 72 respectively. The coupling between the ESD protection device 710, 720, 730, and 740 and the voltage potential line 71 and 72 can be cut off by blowing out the fuses to reduce unnecessary burden to the signal transmission when the chip is packaged and integrated, and the ESD protection device inside the integrated circuit is not needed. There is also no ESD protection circuit disposed in the aforementioned application of the fuse 701 and 703 to protect the fuse701 and 703.

All of the US patents of related art described above are explained in detail in their original documents. The present exposure is intended to explain only the ESD protection patterns thereof. Please refer to the original documents for other related content.

Programmable devices are widely used, but the damage caused by ESD may be more serious due to the lack of effective ESD protection apparatus. As a result, irremediable damage may take place and affect the normal functions of integrated circuits.

### SUMMARY OF THE INVENTION

Accordingly, the present invention is directed to provide an electrostatic discharge (ESD) protection apparatus for a programmable device, which may produce a lower impedance current path to prevent damages to the integrated circuit caused by ESD, improve the stability of the circuit, reduce area cost of the chip, and increase the turn-on efficiency for ESD protection by coupling transistors to both ends of the programmable device.

To accomplish the aforementioned and other objectives, the present invention provides an ESD protection apparatus for a programmable device, which includes a programmable device, a first circuit, a second circuit, a third circuit, and an ESD protection device. The programmable device has a first terminal and a second terminal for recording the programming result. The first circuit is electrically connected between the first terminal of the programmable device and a first node. The second circuit is electrically connected between the second terminal of the programmable device and a second node. Wherein, the programming of the programmable device is performed through the first circuit and the second circuit, and/or the programming result of the said programmable device is obtained through the first circuit and the second circuit. The first terminal and the second terminal of the ESD protection device are coupled to the first terminal and the second terminal of the programmable device respectively. The ESD protection device will provide a current path to avoid damaging the programmable device when ESD occurs. On the other hand, the aforementioned ESD protection device will cancel the current path when there is no ESD.

According to an embodiment of the present invention, an ESD protection apparatus for a programmable device is provided, wherein the programmable device may be a fuse device.

According to an embodiment of the present invention, an ESD protection apparatus for a programmable device is provided, wherein the first node is coupled to the pad, and the second node is coupled to one of the power supply voltage line or the ground voltage line according to the requirement of the circuit.

According to an embodiment of the present invention, an ESD protection apparatus for a programmable device is provided, wherein the ESD protection device includes a diode having its anode and cathode coupled to the first terminal and the second terminal of the programmable device in reverse bias.

According to an embodiment of the present invention, an ESD protection apparatus for a programmable device is provided, wherein the ESD protection device includes a transistor having its source and drain coupled to the first terminal and the second terminal of the programmable device respectively, and the ESD protection apparatus further includes a third circuit coupled to the gate of the transistor and used for controlling whether the ESD protection device provides a current path. The third circuit may be a conducting wire or a resistor when the transistor is a P-type transistor. If the third circuit is a conducting wire, two ends of the conducting wire are coupled to the gate of the P-type transistor and the power supply voltage line respectively; if the said third circuit is a resistor, two ends of the resistor are coupled to the gate of the P-type transistor and the power supply voltage line respectively. The third circuit may be a conducting wire or a resistor when the transistor is an N-type transistor. If the third circuit is a conducting wire, two ends of the conducting wire are coupled to the gate of the N-type transistor and the ground voltage line respectively; if the third circuit is a resistor, two ends of the resistor are coupled to the gate of the N-type transistor and the ground voltage line respectively.

On the other hand, according to an embodiment of the present invention, an ESD protection apparatus for a programmable device is provided, wherein the third circuit allows the ESD protection device to provide a current path. Accordingly, when the status of the programmable device is blown, the signal read by the read circuit is changed by providing a current path, so that the flexibility in circuit usage and the application range of the one time device may be increased.

As shown in the embodiments, the present invention may improve ESD protection capability and turn-on efficiency of a programmable device by providing another current path for the programmable device. The ESD current can be bypassed to avoid damages to the programmable device when ESD occurs. Meanwhile, with the design of the third circuit, it can be used in a programmable device ESD protection apparatuses of different types of circuits, including between the ground voltage line and the pad, between the power supply voltage line and the pad, between IC and IC, and in a single programmable device (e.g. one time program memory). Those of ordinary skill in the art should understand from the disclosure how to apply the present invention in related areas using the programmable devices.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of U.S. Pat. No. 6,654,304.

FIG. 2 is a circuit diagram of U.S. Pat. No. 6,157,241.

FIG. 3 is circuit diagram 1 of U.S. Pat. No. 6,762,918.

FIG. 4 is circuit diagram 2 of U.S. Pat. No. 6,762,918.

FIG. 5 is a circuit diagram of U.S. Pat. No. 6,469,884.

FIG. 6 is a circuit diagram of U.S. Pat. No. 6,327,125.

FIG. 7A is a block diagram illustrating the circuit of an ESD protection apparatus using an N-type transistor as the ESD protection device applied at a power supply side according to an embodiment of the present invention.

FIG. 7B is a block diagram illustrating the circuit of an ESD protection apparatus using an N-type transistor as the ESD protection device applied at a ground side according to an embodiment of the present invention.

FIG. 8A is a block diagram illustrating the circuit of an ESD protection apparatus using a P-type transistor as the ESD protection device applied at a power supply side according to an embodiment of the present invention.

FIG. 8B is a block diagram illustrating the circuit of an ESD protection apparatus using a P-type transistor as the ESD protection device applied at a ground side according to an embodiment of the present invention.

FIG. 9A is a block diagram illustrating the circuit of an ESD protection apparatus wherein the ESD protection device is formed by coupling the gate of an N-type transistor to the ground voltage line and is applied at a power supply side according to an embodiment of the present invention.

FIG. 9B is a block diagram illustrating the circuit of an ESD protection apparatus wherein the ESD protection device is formed by coupling the gate of an N-type transistor to the ground voltage line and is applied at a ground side according to an embodiment of the present invention.

FIG. 10A is a block diagram illustrating the circuit of an ESD protection apparatus wherein the ESD protection device is formed by coupling the gate of a P-type transistor to the power supply voltage line and is applied at a power supply side according to an embodiment of the present invention.

FIG. 10B is a block diagram illustrating the circuit of an ESD protection apparatus wherein the ESD protection device is formed by coupling the gate of a P-type transistor to the power supply voltage line and is applied at a ground side according to an embodiment of the present invention.

FIG. 11A is a block diagram illustrating the circuit of an ESD protection apparatus wherein the ESD protection device is formed by coupling the gate of an N-type transistor to a resistor and is applied at a power supply side according to an embodiment of the present invention.

FIG. 11B is a block diagram illustrating the circuit of an ESD protection apparatus wherein the ESD protection device is formed by coupling the gate of an N-type transistor to a resistor and is applied at a ground side according to an embodiment of the present invention.

FIG. 12A is a block diagram illustrating the circuit of an ESD protection apparatus wherein the ESD protection device is formed by coupling the gate of a P-type transistor to a resistor and is applied at a power supply side according to an embodiment of the present invention.

FIG. 12B is a block diagram illustrating the circuit of an ESD protection apparatus wherein the ESD protection device is formed by coupling the gate of a P-type transistor to a resistor and is applied at a ground side according to an embodiment of the present invention.

FIG. 13 is a circuit diagram of an ESD protection apparatus wherein the ESD protection device is formed by coupling the gate of an N-type transistor to the ground voltage line according to an embodiment of the present invention.

FIG. 14A is a block diagram illustrating the circuit of an ESD protection apparatus using a diode as the ESD protection device applied at a power supply side according to an embodiment of the present invention.

FIG. 14B is a block diagram illustrating the circuit of an ESD protection apparatus using a diode as the ESD protection device applied at a ground side according to an embodiment of the present invention.

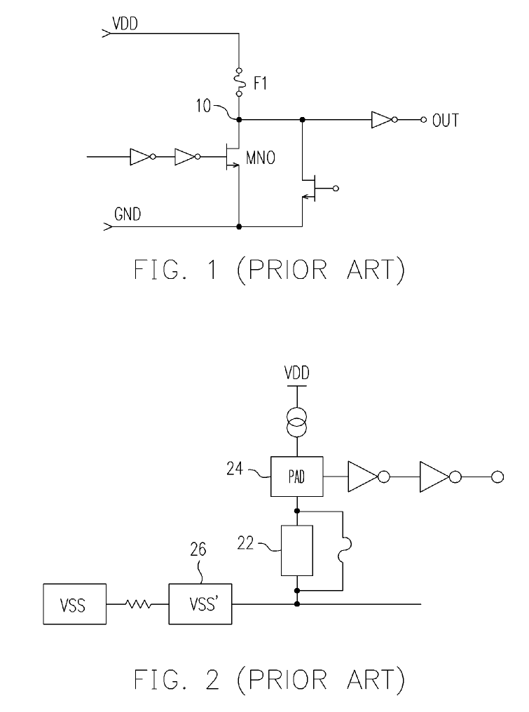

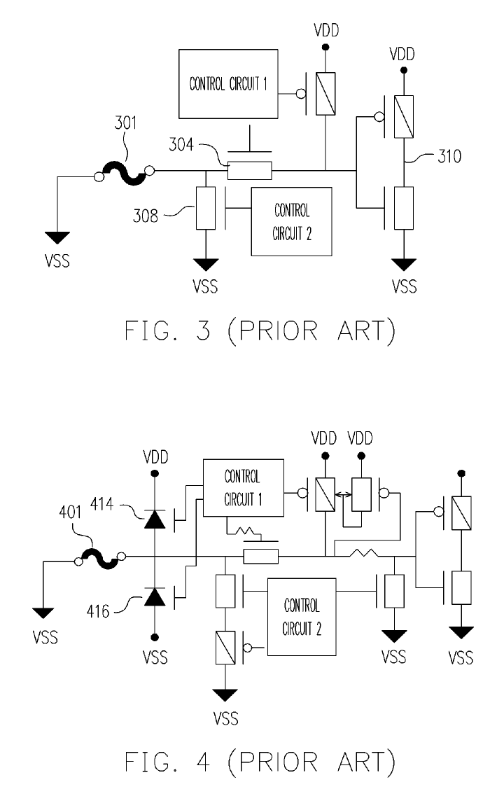

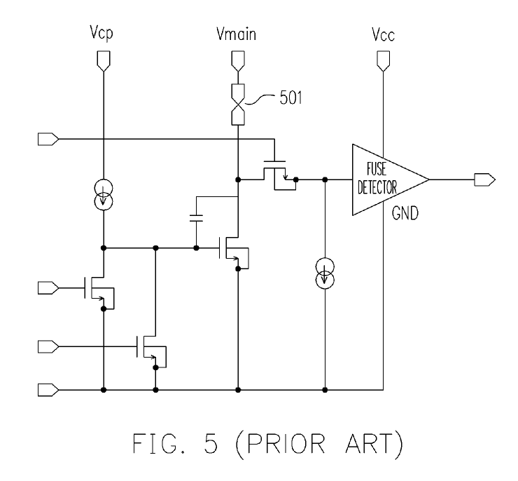

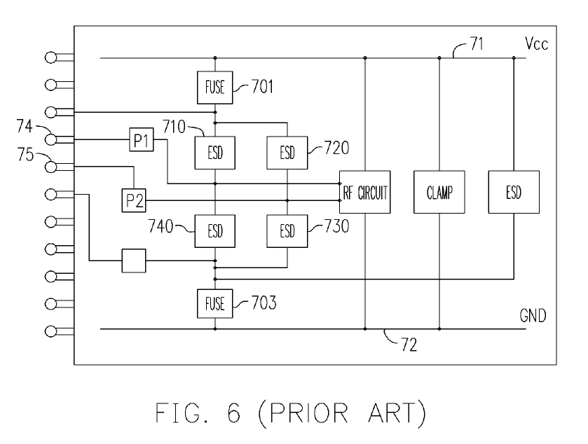

### DESCRIPTION OF EMBODIMENTS

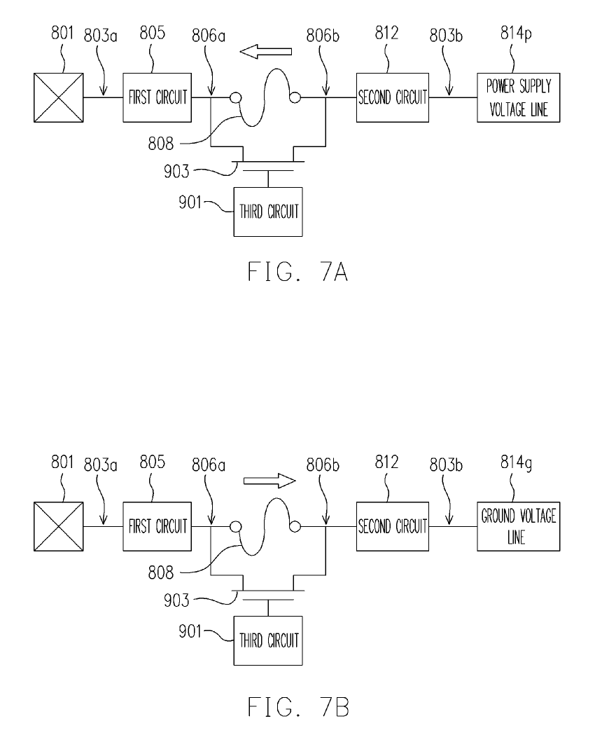

FIG. 7A illustrates an electrostatic discharge (ESD) protection apparatus for a programmable device according to an embodiment of the present invention. The ESD protection apparatus includes a programmable device 808, a first circuit 805, a second circuit 812, a third circuit 901, and an ESD protection device 903. The programmable device 808 is used for recording the programming result. In an embodiment, the programmable device 808 is a fuse having a first terminal 806a and a second terminal 806b for recording the programming result. The first circuit 805 is electrically connected between the first terminal 806a of the programmable device 808 and the first node 803a. The second circuit 812 is electrically connected between the second terminal 806b of the programmable device 808 and the second node 803b. Wherein, the programming of the programmable device 808 is performed through the first circuit 805 and the second circuit 812, and the programming result of the programmable device 808 is obtained by enabling the first circuit 805 and the second circuit 812 and sensing the current passing through the programmable device 808. In the present embodiment, the ESD protection device 903 is an N-type transistor (NMOS) having its first terminal (source) and its second terminal (drain) coupled to the first terminal 806a and the second terminal 806b of the programmable device 808 respectively. The third circuit 901 is electrically connected to the gate of the ESD protection device 903 for controlling the ESD protection device 903. In the present embodiment, the first node 803a and the second node 803b are electrically connected to the pad 801 and the power supply voltage line 814p respectively. When ESD occurs, the ESD protection device 903 has an interface breakdown between N-type dopant and P-well (N⁺/PW) and forms a low impedance current path to bypass transient ESD current produced by the ESD so that the voltage difference between the first terminal 806a and the second terminal 806b of the programmable device 808 may be reduced to lower than the blow voltage, and furthermore the entire programmable device 808 is protected to achieve the ESD protection purpose. When the circuit is working properly and there is no ESD, the current path is cancelled so that the programmable device 808 can work properly without being affected by the ESD protection device 903. Another function of the aforementioned ESD protection device 903 is to provide another current path to the blown programmable device 808. With the control of the third circuit 901, terminals 806a and 806b of the programmable device 808 may be turned from an open circuit into short circuit to change the electrical connection status of the two terminals to increase the flexibility of the programmable device 808 in actual application. In all the embodiments herein, same reference numerals refer to the same elements throughout.

FIG. 7B illustrates an ESD protection apparatus for a programmable device according to another embodiment of the present invention, wherein the main difference from FIG. 7A described above is that the second node 803b thereof is electrically connected to the ground voltage line 814g. Those skilled in the art should understand from the disclosure that the ESD protection function of the ESD protection device 903 is not affected by whether the second node 803b is coupled to the power supply voltage line 814p or to the ground voltage line 814g. In FIGS. 7A and 7B, the same reference numerals refer to the same elements, and the specific connection pattern thereof is as described in the embodiment of FIG. 7B.

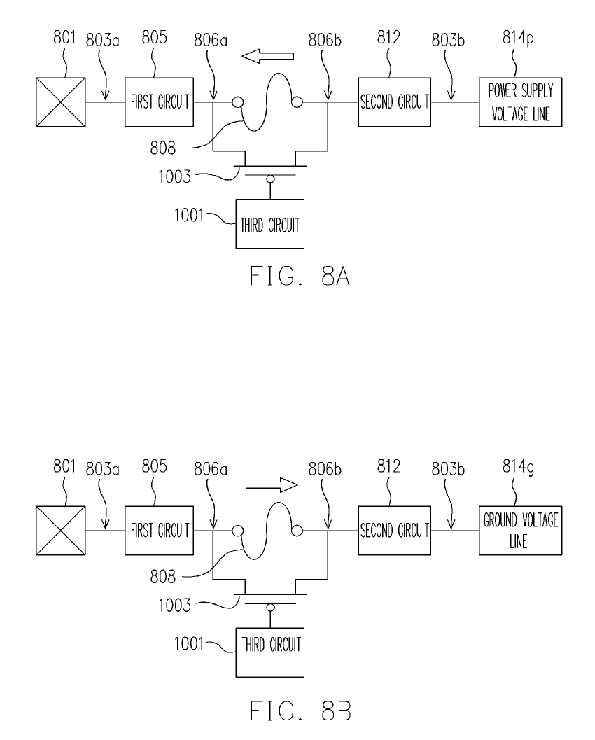

FIG. 8A illustrates an ESD protection apparatus for a programmable device according to another embodiment of the present invention, wherein the main difference from FIG. 7A described above is at the ESD protection device 1003. Referring to FIG. 8A, in the present embodiment, the ESD protection device 1003 is a P-type transistor (PMOS) having its first terminal (drain) and its second terminal (source) coupled to the first terminal 806a and the second terminal 806b of the programmable device 808 respectively. The third circuit 1001 is electrically connected to the gate of the ESD protection device 1003 for controlling the ESD protecting device 1003 which is kept in a normally off status when there is no ESD, so that the programmable device 808 can work properly unaffected by the ESD protection device 1003.

When ESD occurs, the ESD protection device 1003 has interface breakdown between P-type dopant and N-well (P⁺/NW) and forms a low impedance current path to bypass transient ESD current produced by the ESD, so that the voltage difference between the first terminal 806a and the second terminal 806b of the programmable device 808 may be reduced to lower than the blow voltage, and further the entirety of the programmable device 808 is protected to achieve the ESD protection purpose. Same reference numerals in FIG. 8A refer to the same elements in aforementioned embodiments unless otherwise specified, same to related links.

FIG. 8B illustrates an ESD protection apparatus for a programmable device according to another embodiment of the present invention, wherein the main difference from FIG. 8A above described is that the second node 803b is electrically connected to the ground voltage line 814g. Like reference numerals in FIG. 8B, refer to the same elements in aforementioned embodiments unless otherwise specified. Those skilled in the art should understand from the disclosure that the ESD protection function of the ESD protection device 1003 and the ESD protection device 903 will not be affected by whether the second node 803b is coupled to the power supply voltage line 814p or to the ground voltage line 814g, and this applies to all the following embodiments.

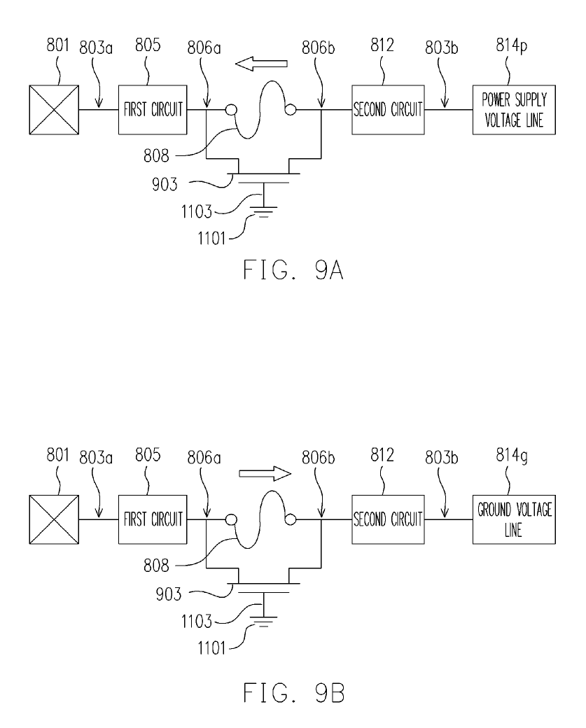

FIG. 9A illustrates an ESD protection apparatus for a programmable device according to another embodiment of the present invention, wherein the main difference to FIG. 7A is that, the gate of the ESD protection device 903 is electrically connected to one end of the conducting wire 1103, and the other end of the conducting wire 1103 is electrically connected to the ground voltage line 1101, so that the ESD protection device 903 stays in normally off status when there is no ESD and the programmable device can work properly unaffected by the ESD protection device 903. When ESD occurs, the ESD protection device 903 has interface breakdown between N-type dopant and P-well (N⁺/PW) and will form a low impedance current path to bypass transient ESD current produced by the ESD to protect the programmable device from the damage of the ESD. Similarly, this ESD protection apparatus also applies to the ESD protection when the second node 803b is coupled to the ground voltage line 814g, as shown in FIG. 9B. Same reference numerals in FIGS. 9A and 9B refer to the same elements in FIG. 7A unless otherwise specified.

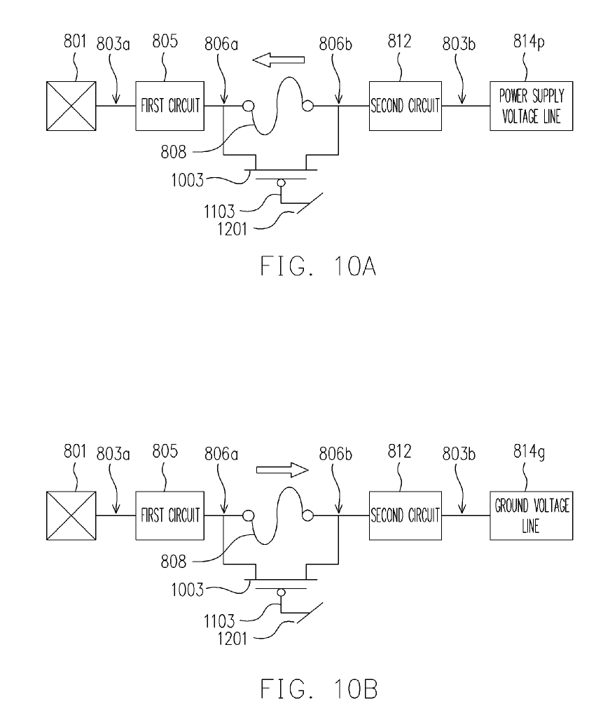

FIG. 10A illustrates an ESD protection apparatus for a programmable device according to another embodiment of the present invention, wherein the main difference from FIG. 8A described above is that the gate of the ESD protection device 1003 is coupled to one end of the conducting wire 1103 and the other end of the conducting wire 1103 is coupled to the power supply voltage line 1201 to keep the ESD protection device 1003 in normally off status. Similarly, when ESD occurs, the ESD protection device 1003 has interface breakdown between P-type dopant and N-well (P⁺/NW) and will forms a low impedance current path to protect the programmable device from damage of the ESD. The present embodiment also applies to the ESD protection between the ground voltage line 814g and the pad 801, as shown in FIG. 10B. Same reference numerals in FIGS. 10A and 10B refer to the same elements in FIG. 8A unless otherwise specified. Please refer to the description of the embodiment in FIG. 8A for related links.

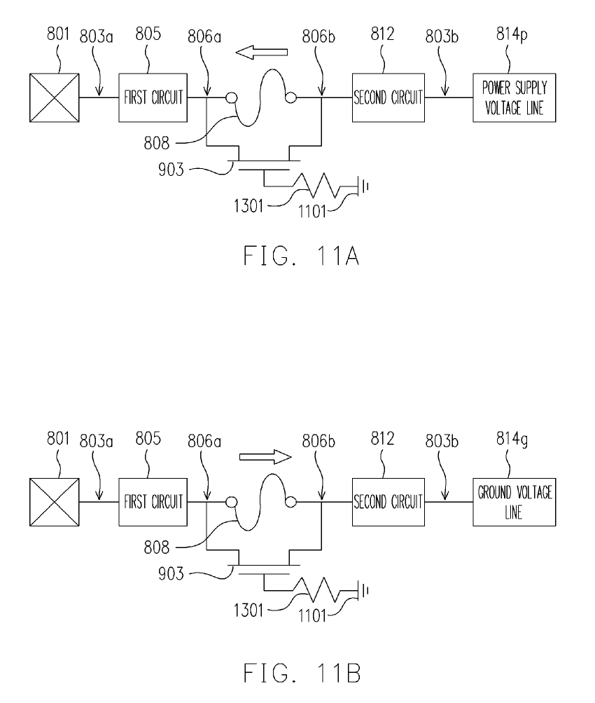

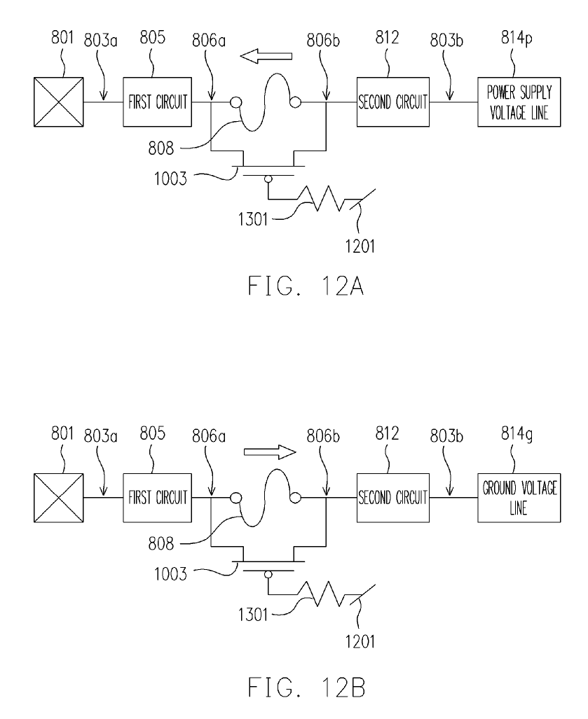

FIG. 11A illustrates an ESD protection apparatus for a programmable device according to another embodiment of the present invention, wherein the main difference from FIG. 7A is that the gate of the ESD protection device 903 is coupled to one end of the resistor 1301, and the other end of the resistor 1301 is coupled to the ground voltage line 1101 to keep the ESD protection device 903 in normally off status, so that the programmable device 808 can work properly unaffected by the ESD protection device 903 when there is no ESD. When ESD occurs, the ESD protection device 903 has interface breakdown between N-type dopant and P-well (N⁺/PW), and ESD current is produced between the gate of the ESD protection device 903 and the ground voltage line 1101 due to parasitic capacitance coupling between the source and the gate of the ESD protection device 903. The gate/source voltage of the ESD protection device 903 can be increased to greater than the threshold voltage by the resistor 1301 to turn on the ESD protection device 903, lower the impedance of the current path thereof, increase the turn-on speed of the ESD protection device 903 when ESD occurs, and avoid damage to the programmable device 808 from the ESD current. Similarly, the present embodiment also applies to the ESD protection between the ground voltage line 814g and the pad 801, as shown in FIG. 11B. Same reference numerals in FIGS. 11A and 11B refer to the same elements in FIG. 8A unless otherwise specified.

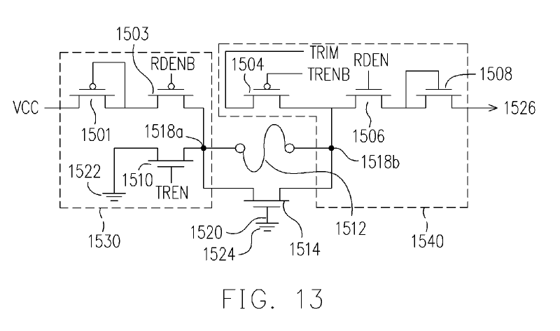

FIG. 12A illustrates an ESD protection apparatus for a programmable device according to another embodiment of the present invention, wherein the main difference from FIG. 8A is that the gate of the ESD protection device 1003 is coupled to one end of the resistor 1301, the other end of the resistor 1301 is coupled to the power supply voltage line 1201 to keep the ESD protection device 1003 in normally off status, so that the programmable device 808 can work properly unaffected by the ESD protection device 1003 when there is no ESD, and the resistor 1301 allows the gate voltage of the ESD protection device 1003 to be negative voltage lower than the threshold voltage of the ESD protection device 1003 through the parasitic capacitance coupling between the drain and the gate of the ESD protection device 1003 when ESD occurs, to turn on the ESD protection device 1003. Meanwhile the ESD protection device 1003 has interface breakdown between P-type dopant and N-well (P⁺/NW) to lower the impedance of the current path thereof and increase the turn-on speed of the ESD protection device 1003 when ESD occurs, so that the programmable device 808 can get higher ESD protection efficiency. Similarly, this ESD protection apparatus also applies to the ESD protection between the ground voltage line 814g and the pad 801, as shown in FIG. 12B. Same reference numerals in FIGS. 12A and 12B refer to the same elements in FIG. 8A unless otherwise specified, and those elements not described in the present embodiment are as described in the embodiment of FIG. 8A.

FIG. 13 illustrates an ESD protection apparatus for a programmable device according to another embodiment of the present invention, wherein the ESD protection apparatus includes a first circuit 1530, a second circuit 1540, a programmable device (fuse) 1512, an ESD protection device 1514, and a conducting wire 1520. The first circuit 1530 includes P-type transistors (PMOS) 1501 and 1503, and an N-type transistor (NMOS) 1510. The second circuit includes N-type transistors 1506 and 1508, and a P-type transistor 1504. The source of the P-type transistor 1501 is coupled to the power supply voltage line VCC, and the gate of the P-type transistor 1501 is coupled to the drain thereof. The source of the transistor 1503 is coupled to the drain of the transistor 1501, the gate of the transistor 1503 is coupled to a read enable voltage RDEMB, and the drain thereof is coupled to the first terminal 151 8a of the programmable device 1512. The drain of the transistor 1510 is coupled to the first terminal 1518a of the programmable device 1512, the gate thereof is coupled to a write enable voltage TREN, and the source thereof is coupled to a ground voltage source 1522. Both ends (source and drain) of the ESD protection device 1514 are coupled to the first terminal 1518a and the second terminal 1518b of the programmable device respectively, and the gate of the ESD protection device 1514 is coupled to one end of the conducting wire 1520. The other end of the conducting wire 1520 is coupled to the ground voltage line 1524. The body and the source of the transistor 1504 are coupled to the voltage source TRIM, and the drain thereof is coupled to the second terminal 1518b of the programmable device 1512. The drain of the transistor 1506 is coupled to the second terminal 1518b, the gate thereof is coupled to the read enable voltage RDEN, and the source thereof is coupled to the drain of the transistor 1508. The gate and the drain of the transistor 1508 are coupled to each other, and the source of the transistor 1508 is coupled to the current sensing terminal 1526.

In an embodiment, the programmable device 1512 can perform blow and read operations through the first circuit and the second circuit. When the programmable device 1512 is performing a blow operation, transistors 1504 and 1510 are turned on due to the enabling of the write enable voltage TRENB and TREN. The current of the write voltage source TRIM passes through the transistor 1504, the programmable device 1512, and the transistor 1510 to reach the ground voltage source 1522. The programmable device 1512 is blown due to the heat produced by the increase of the turn-on current; that is, an open circuit is formed to accomplish the write operation. When the programmable device 1512 is performing a read operation, transistors 1503 and 1506 are turned on by the read enable voltage RDENB and RDEN to form a turn-on channel from the power supply voltage line VCC to the current sensing terminal 1526 through the transistor 1501, the transistor 1503, the programmable device 1512, the transistor 1506, and the transistor 1508. Therefore, the entirety or blown status of the programmable device 1512 can be determined based on whether there is a current at the current sensing terminal 1526. During the operation of the circuit, the ESD protection device 1514 stays in normally off status and the current path is cancelled to ensure the programmable device 1512 works properly unaffected by the ESD protection device 1514 if there is no ESD. A current path is provided to avoid damage to the programmable device 1512 from ESD current when ESD occurs. That is, when ESD occurs, the ESD protection device 1512 has interface breakdown between N-type dopant and P-well (N⁺/PW) and forms a low impedance current path to bypass transient ESD current produced by the ESD, and furthermore reduces the voltage drop between two ends of the programmable device 1512 to lower than the blow voltage, so that the entirety of the programmable device 808 is protected and the ESD protection function is achieved.

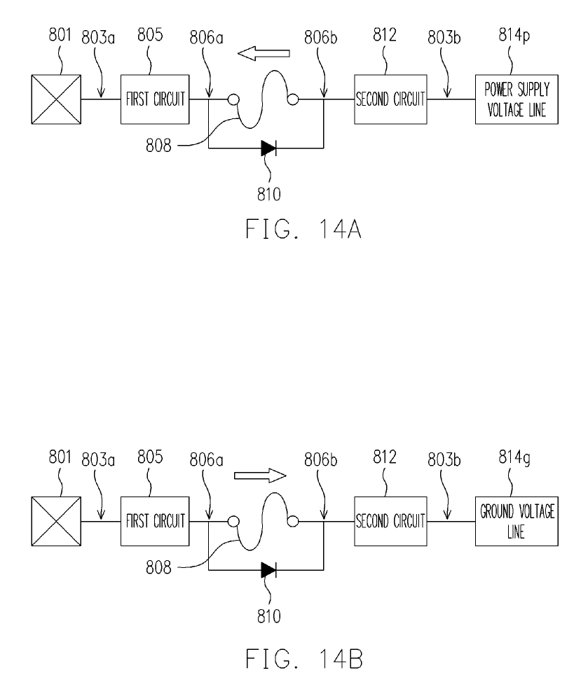

FIG. 14A illustrates an ESD protection apparatus for a programmable device according to another embodiment of the present invention, which includes a programmable device 808 having a first terminal 806a and a second terminal 806b for recording the programming result. In an embodiment, the programmable device 808 is a fuse. The first circuit 805 is electrically connected between the first terminal 806a of the programmable device 808 and the first node 803a; the second circuit 812 is electrically connected between the second terminal 806b of the programmable device 808 and the second node 803b, wherein the programming in the programmable device 808 is performed by the first circuit 805 and the second circuit 812, and the programming result of the programmable device 808 is obtained by the first circuit 805 and the second circuit 812. In the present embodiment, the aforementioned ESD protection device 810 is a diode having its first terminal (anode of the diode) and its second terminal (cathode of the diode) coupled to the first terminal 806a and the second terminal 806b of the programmable device 808 in reverse bias respectively. The pad 801 is electrically connected to the first node 803a; the second node 803b is electrically connected to the power supply voltage line 814p. The diode 810 is off because the reversed biased voltage doesn't reach the reverse breakdown voltage thereof when there is no ESD, so that the programmable device 808 may work properly unaffected by the diode 810. When ESD occurs, the ESD protection device 810 has NP interface breakdown and forms a low impedance current path to bypass transient ESD current produced by the ESD to reduce the voltage difference between the first terminal 806a and the second terminal 806b of the programmable device 808 to lower than the blow voltage and to avoid damages to the programmable device 808 caused by the ESD and achieve the ESD protection function. Similarly, this ESD protection apparatus also applies to the ESD protection between the ground voltage line 814g and the pad 801, as shown in FIG. 14B. Another main difference between FIGS. 14B and 14A is that the first terminal (anode of the diode) and the second terminal (cathode of the diode) of the ESD protection device 810 are coupled to the second terminal 806b and the first terminal 806a of the programmable device 808 in reverse bias respectively. Those skilled in the art should be able to infer the ESD protection mechanism of FIGS. 14B and 14A from the disclosure. Same reference numerals in FIG. 14B refer to the same elements in FIG. 14A.

In overview, the present invention may improve the ESD protection capability and response speed of a programmable device as ESD occurs, by providing another current path to the programmable device. The ESD current may be bypassed to avoid damage to the programmable device when ESD occurs. Meanwhile, with the design of the third circuit, the ESD protection apparatus for programmable device may be used in different types of circuits, including between the ground voltage line and the pad, between the power supply voltage line and the pad, between IC and IC, and in single programmable device (e.g. one time program memory). Those with ordinary skill in the art should be able to apply the present invention in related areas using programmable devices from the teachings of aforementioned embodiments.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electrostatic discharge (ESD) protection apparatus for a programmable device, the protection apparatus comprising:
a programmable device having a first terminal and a second terminal for recording the programming result;
a first circuit electrically connected between the first terminal of the programmable device and a first node;
a second circuit electrically connected between the second terminal of the programmable device and a second node, wherein the programming in the programmable device is performed by the first circuit and the second circuit, and/or the programming result of the programmable device is obtained by the first circuit and the second circuit; and
an ESD protection device having its first terminal and its second terminal coupled to the first terminal and the second terminal of the programmable device to provide a current path to avoid damages to the programmable device from the ESD current when ESD occurs, and to cancel the current path when there is no ESD.

2. The ESD protection apparatus as claimed in claim 1, wherein the programmable device is a fuse.

3. The ESD protection apparatus as claimed in claim 1, wherein the first node is coupled to a pad and the second node is coupled to a power supply voltage line.

4. The ESD protection apparatus as claimed in claim 1, wherein the first node is coupled to a pad and the second node is coupled to a ground voltage line.

5. The ESD protection apparatus as claimed in claim 1, wherein the ESD protection device includes a diode having its anode and its cathode coupled to the first terminal and the second terminal of the programmable device in reverse bias respectively.

6. The ESD protection apparatus as claimed in claim 1, wherein the ESD protection device includes a transistor having its source and its drain coupled to the first terminal and the second terminal of the programmable device respectively, and the ESD protection apparatus further includes:
a third circuit coupled to the gate of the transistor for controlling whether the ESD protection device provides the current path.

7. The ESD protection apparatus as claimed in claim 6, wherein the transistor is a P-type transistor.

8. The ESD protection apparatus as claimed in claim 7, wherein the third circuit includes a conducting wire having its two ends coupled to the gate of the transistor and a power supply voltage line respectively.

9. The ESD protection apparatus as claimed in claim 7, wherein the third circuit includes a resistor having its two ends coupled to the gate of the transistor and a power supply voltage line respectively.

10. The ESD protection apparatus as claimed in claim 6, wherein the transistor is an N-type transistor.

11. The ESD protection apparatus as claimed in claim 10, wherein the third circuit includes a conducting wire having its two ends coupled to the gate of the transistor and a ground voltage line respectively.

12. The ESD protection apparatus as claimed in claim 10, wherein the third circuit includes a resistor having its two ends coupled to the gate of the transistor and a ground voltage line respectively.
